(19) United States
(12) Patent Application Publication
(10) Pub. No.: US 2023/0257863 A1
(43) Pub. Date: Aug. 17, 2023

(54) GLASS SUBSTRATE WITH A BASE FILM TO IMPROVE ADHESION OF THERMAL SPRAY COATING, AND GLASS PARTS WITH THERMAL SPRAY COATING

(71) Applicant: Techno Quartz Inc., Tokyo (JP)

(72) Inventors: Masahide KATO, Yamagata-shi, Yamagata (JP); Yasuhiro Umetsu, Yamagata-shi (JP); Yo Mastuura, Yamagata-shi (JP)

(21) Appl. No.: 18/163,017

(22) Filed: Feb. 1, 2023

(30) Foreign Application Priority Data
Feb. 15, 2022 (JP) 2022-021603

(51) Int. Cl. C23C 4/11; C03C 17/34; C03C 17/36

(52) U.S. Cl. CPC C23C 4/11; C03C 17/3417; C03C 17/3482; C03C 17/3607

(57) ABSTRACT

Provided are a glass substrate with a metal or ceramic coating formed, where a base film for enhancing the adhesion between the base surface of the glass substrate and the coating is provided in the region with the coating formed, and a glass part obtained by further forming a coating of a metal or a ceramic on the glass substrate.

### BACKGROUND OF THE INVENTION

### 1. Technical Field

The present invention relates to a glass substrate with a base film for improving the adhesion of a thermal spray coating, and a glass part with a thermal spray coating, and more particularly relates to a glass substrate with the enhanced adhesion of a metal or ceramic coating such as a sprayed coating, and a glass part with the glass substrate used.

### 2. Description of the Related Art

Conventionally, quartz glass materials have been widely used as chamber constituent members of apparatuses for manufacturing devices such as semiconductors or flat panel displays. For such chamber constituting members made of quartz glass (hereinafter, referred to as “glass substrates”), depending on the applications, the surfaces of the glass substrates are coated with thermal spray coatings of metals, ceramics, or the like for improving various performances. For example, JP 2002-249864 A proposes a halogen-gas plasma-resistant member exposed to halogen-gas plasma, including a main body for the member and a corrosion-resistant film formed on at least a surface of the main body, where a material for the corrosion-resistant film is sprayed to form a sprayed film to cause the corrosion-resistant film to be 15 MPa or more in peeling strength with respect to the main body.

Further, conventionally, inner members for plasma treatment containers with excellent resistance to plasma erosion have also been proposed. For example, JP 2001-164354 A proposes an inner member for a plasma treatment container, where a substrate has a surface covered with a multilayer composite layer including a metal coating formed as an undercoat layer, an alumina (Al₂O₃) coating formed as an intermediate layer on the undercoat layer, and an yttria (Y₂O₃) sprayed coating formed as a topcoat layer on the intermediate layer.

In addition, techniques for regenerating quartz glass parts that have substrate surfaces coated with thermal spray coatings have also been proposed. For example, JP 2008-95132 A relates to a system component disposed in a vacuum deposition system, an etching system, a pre- cleaning system, or an ashing device in a process of manufacturing a semiconductor device, and proposes, as a system component that facilitates the removal of adhering filmy substances in the maintenance of the system, a system component including an electrically insulating substrate, a metal sprayed film formed on the surface of the electrically insulating substrate, and a ceramic sprayed film formed on the surface of the metal sprayed film, where the surface of the ceramic sprayed film falls within the range of 10 to 50 μm in center line average roughness Ra.

### SUMMARY OF THE INVENTION

As described above, it is known that a surface of a glass substrate is coated with a coating, and furthermore, JP 2001-164354 A proposes the inner member for a plasma treatment container, where the yttria (Y₂O₃) sprayed coating is provided as a topcoat layer on the intermediate layer made of the alumina (Al₂O₃) coating, for improving the resistance to plasma erosion. The lowermost layer (undercoat layer) in this document, however, is a metal coating, and no consideration is made at all in terms of improving the adhesion to the substrate.

In particular, in recent years, there have been increasing needs for 3R (Reduce, Reuse, Recycle) for consumable members for the purpose of reducing the environmental load and reducing the cost, and for example, increasing needs for extending the lives of consumable parts by the formation of coatings as protective films, and further, for recycling consumed or deteriorated coatings. In relation to these needs, the coatings tend to be thickened for reasons such as improving the durability of the protective films and forming functional patterns on the protective films themselves. Further, the coatings thickened as described above are also believed to cause defects such as film peeling and substrate fracture due to the influence of film stress, conventionally in the case of mere thermal spraying onto blasted rough surfaces.

Accordingly, an object of the present invention is to provide a highly versatile glass substrate capable of sufficiently securing the adhesion to a thermal spray coating even when the thermal spray coating is formed to as a thick film, and a glass part with a thermal spray coating provided on the glass substrate.

In addition, when quartz glass parts provided with the thermal spray coatings are excessively consumed or deteriorated in actual use environments, the thermal spray coatings are regenerated and recycled. As a method for regenerating such a thermal spray coating, a method of mechanically removing a consumed or deteriorated coating by a blasting treatment or the like, or a method of chemically etching the substrate itself is commonly implemented, but these methods have the problem of causing the substrate itself to change in dimension or surface roughness, and then shorten the life of the part.

Accordingly, another object of the present invention is to provide, for the regeneration of a thermal spray coating, a glass part provided with a thermal spray coating, which allows the changes in the dimensions and surface roughness of a substrate itself to be reduced as much as possible, and a method for regenerating the thermal spray coating of the glass part.

In order to solve at least any one of the problems mentioned above, the present inventors have found that a base film for enhancing the adhesion between the base of a glass substrate and a thermal spray coating is provided in a region of the glass substrate where a thermal spray coating is to be formed, and achieved the present invention.

More specifically, the present invention provides a glass substrate with a metal or ceramic coating formed, where a base film for enhancing the adhesion between the base surface of the glass substrate and the coating is provided in the region with the coating formed.

Further, the present invention provides, in order to solve at least any one of the problems, a glass part formed with the use of the glass substrate according to the present invention, that is, the glass substrate including the base film. Provided is a glass part obtained by forming a coating of a metal or a ceramic on a glass substrate, where the glass substrate is the glass substrate including the base film according to the present invention, and the coating is formed on the base film.

In addition, the present invention provides, in order to solve at least any one of the problems, a method for manufacturing a glass part provided with a thermal spray coating. Provided is a method for manufacturing a glass part obtained by forming a coating of a metal or a ceramic on a glass substrate, the method comprising: a base film forming treatment of forming, on the glass substrate, a base film for enhancing the adhesion between the base surface of the glass substrate and the coating; and a coating forming treatment of forming the coating of the metal or ceramic on the base film formed by the base film forming treatment.

Further, the present invention provides, in order to solve at least any one of the problems, a method for regenerating a glass part provided with a thermal spray coating. More specifically, provided is a method for regenerating a glass part obtained by forming a coating of a metal or a ceramic on a glass substrate, where the glass part has the coating formed on the glass substrate provided with a base film containing yttria (Y₂O₃), and the method includes a base film dissolving treatment of dissolving the base film with a base film dissolving component in which the base film is soluble, whereas the glass substrate is insoluble.

The base film dissolving component may be a gas or a liquid, and can be appropriately selected depending on the material of the base film. As the base film dissolving component, for example, a nitric acid, an aqua regia (a mixed acid of a hydrochloric acid and a nitric acid), or a fluoronitric acid (a mixed acid of a hydrofluoric acid and a nitric acid) can be used. In particular, when the base film is formed from yttria (Y₂O₃) or a material containing yttria, a chemical solution containing nitric acid, such as a nitric acid aqueous solution or aqua regia, can be used as the base film dissolving component.

The glass substrate according to the present invention is provided with the base film for enhancing the adhesion between the base surface of the glass substrate and a thermal spry coating film in the region with the thermal spray coating to be formed, thus allowing the adhesion of various thermal spray coatings such as a sprayed coating to be enhanced, and even when the thermal spray coating is formed as a thick film, allowing for providing a highly versatile glass substrate capable of sufficiently securing the adhesion to the thermal spray coating, and a glass part with a thermal spray coating provided on the glass substrate.

In addition, for the glass part obtained by forming a thermal spray coating on the glass substrate provided with the base film, the thermal spray coating provided on the base film can be removed by electively removing only the base film with a chemical treatment or the like, and thus, for the regeneration of a thermal spray coating, it is possible to provide a glass part provided with a thermal spray coating, which allows the changes in the dimensions and surface roughness of the substrate itself to be reduced as much as possible, and a method for regenerating the thermal spray coating of the glass part.

### BRIEF DESCRIPTION OF THE DRAWINGS

FIG. 1 is a work flow diagram illustrating a process of manufacturing a glass substrate and a quartz glass part with the glass substrate used, according to the present embodiment;

FIG. 2 is a perspective view illustrating the glass part according to the present embodiment;

FIG. 3 shows cross-sectional images of sprayed coatings, which show the porosity for each of cross sections of the sprayed coatings according to Experimental Example 2;

FIG. 4 is a relationship diagram between porosity and tensile strength according to Experimental Example 3;

FIG. 5 is a result of comparison in tensile adhesion strength between Experimental Examples 4 and 5;

FIG. 6 shows photographs that show samples according to Experimental Example 6; and

FIG. 7 shows a quartz glass substrate (A) before immersion, (B) after immersion, and (C) after immersion in a base film dissolving component (nitric acid aqueous solution) according to Experimental Example 6.

### DETAILED DESCRIPTION

Hereinafter, a glass substrate, a glass part formed with the use of the glass substrate, and methods for manufacturing and regenerating the glass part according to the present embodiment will be specifically described with reference to the drawings. In particular, an example of forming a thermal spray coating on one surface of a glass substrate formed in a plate shape is specifically described in the present embodiment, but the glass substrate may have various shapes depending on the application, and the thermal spray coating can also be formed on any surface or region.

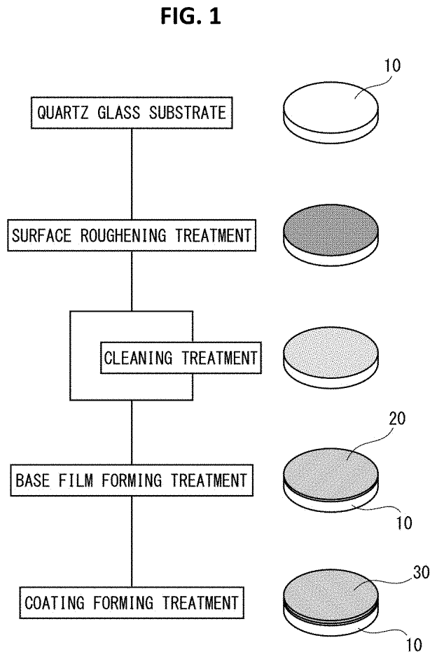

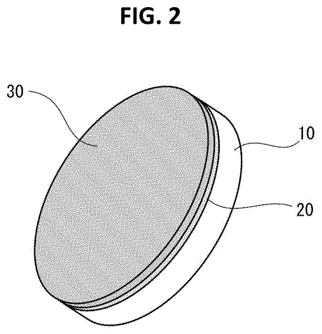

FIG. 1 is a work flow diagram illustrating a process of manufacturing a glass substrate and a quartz glass part with the glass substrate used, according to the present embodiment, and FIG. 2 is a perspective view illustrating the glass part according to the present embodiment.

As illustrated in FIG. 1, a glass substrate 10 is used in the manufacture of the glass part according to the present embodiment. The glass substrate 10 may be soda-lime glass, lead glass, borosilicate glass, or crystallized glass besides quartz glass. In the case of a glass part for use in applications of manufacturing devices such as semiconductors and liquid crystals, the glass substrate 10 with material characteristics depending on the application can be employed. In particular, in the present embodiment, the quartz glass substrate 10 made of quartz glass is used.

Then, for the glass substrate 10, the base surface is subjected to surface roughening (surface roughening treatment) for a region where a thermal spray coating 30 is to be formed, that is, a region where a base film 20 is to be formed (hereinafter, referred to as a “target region”). Such a surface roughening treatment is performed to enhance the adhesion of the base film 20 to the base surface of glass substrate 10. The surface roughing treatment can be performed not only by mechanical abrasive machining such as sand blasting (hereinafter, referred to as “blasting”), lapping, and grinding with a diamond tool, but also by etching with a chemical corrosive action used or the combination of the machining and etching. In particular, in the present embodiment, the surface roughening treatment is performed by blasting. In particular, in the case of surface roughening by blasting, the abrasive grains used for the blasting can be appropriately selected depending on the material (or base surface) to be subjected to grinding, and an alumina abrasive, a silicon carbide abrasive, or the like can be used. When the object to be subjected to grinding is the glass substrate 10 as in the present embodiment, a black silicon carbide abrasive (abbreviation: C) or a green silicon carbide abrasive (abbreviation: GC) can be used.

The surface of the target region will be roughened by such a surface roughening treatment, and the surface roughness can be appropriately adjusted depending on the material of the glass substrate 10 used and the material of the base film 20. For example, in the case of forming the base film 20 of yttria for the quartz glass substrate 10, the surface roughening desirably provides arithmetic mean roughness Ra of 3.5 μm to 5.5 μm or maximum height roughness Rmax of 35 μm to 55 μm for the surface roughness of the target region.

After the surface roughening treatment, a cleaning treatment may be performed, such as chemical cleaning with acid/alkali or physical cleaning with ultrasonic waves used. In particular, the abrasive, grinding sludge, and the like remain on the base surface subjected to the surface roughening treatment by machining, and the base surface is desirably cleaned before proceeding to the next process.

After the surface roughening treatment, the target region is subjected to a base film 20 forming treatment for forming the base film 20. Such a base film forming treatment is intended to form, in the target region, the base film 20 made of a metal or a ceramic, and the base film 20 functions to enhance the adhesion of the thermal spray coating 30 formed thereon.

The base film 20 can be formed as a film containing aluminum, tungsten, molybdenum, titanium, chromium, silicon, ceria, zirconia, lanthanum oxide, yttria, alumina, titania, chromia, magnesia, YAG, yttria-stabilized zirconia, aluminum nitride, silicon nitride, boron carbide, silicon carbide, aluminum carbide, yttrium iodide, yttrium fluoride, aluminum fluoride, calcium fluoride, or the like. In particular, in the present embodiment, the quartz glass substrate 10 is used, and the base film 20 is thus desirably formed as a film containing yttria (Y₂O₃) or silicon (Si), in particular, Y₂O₃. Accordingly, in the present embodiment, the base film 20 is desirably formed as a layer containing Y₂O₃ as a main component and containing 90 wt % or more, in particular, 99 wt % or more of Y₂O₃. It is to be noted that when the glass substrate 10 is made of another material, the base film 20 can be made of another material as a matter of course.

The base film 20 can be formed by a thermal spraying method, and can be formed by a chemical vapor deposition method (CVD), an atomic layer deposition method (ALD), a sputtering method, a vapor deposition method, a plating method, or a coating method. In consideration of film formation time and cost, applications of manufacturing devices such as semiconductors and liquid crystals, adhesion, and the like, however, the formation by a thermal spraying method is desirable. In particular, in the case of forming the base film 20 by a thermal spraying method, the base film 20 can be formed by oxygen fuel spraying (flame spraying, high velocity flame spraying, detonation flame spraying), electric spraying (arc spraying, plasma spraying, or wire explosion spraying), or cold spraying. In the present embodiment, the base film 20 is formed by a thermal spraying method.

Further, the base film 20 is desirably formed to have a porosity of 10% or less, more preferably 5% or less. In this regard, if the porosity of the base film 20 exceeds 10%, it is conceivable that voids or pores distributed in the vicinity of the interface between the base film 20 and the substrate material base material will degrade the adhesion due to the anchor effect, or the base film itself will be made fragile. Thus, the porosity of the base film 20 is adjusted to be 10% or less, more preferably 5% or less, thereby allowing the problems regarding the adhesion and bulk strength of the base film 20 to be solved. As presented in the present embodiment, the base film 20 made of yttria (Y₂O₃) can also be controlled to have the porosity by a thermal spraying method (for example, atmospheric plasma spraying method) or the like. In addition, the porosity of the base film 20 can be calculated, based on, for example, a method such as measuring the area of a pore portion from an enlarged photograph of a cross section of the thermal spray coating.

The thickness of the base film 20 is at least equal to or larger than the value of the maximum height roughness Rmax of the base surface of the glass substrate 10, and more desirably equal to or larger than a value obtained by adding the value of the maximum height roughness Rmax of the base film 20 to the value of the maximum height roughness Rmax of the base surface of the glass substrate 10. Thus, the adhesion between the glass substrate 10 provided with the base film 20 and the thermal spray coating 30 can be enhanced, and the thermal spray coating 30 and the base layer can be reliably removed for regenerating the glass part to be described later.

The glass substrate 10 provided with the base film 20 can be formed by the foregoing base film 20 forming treatment. The glass substrate 10 has the base film 20, thus allowing an improvement in adhesion to the thermal spray coating 30 provided thereon, and removing only the base film 20 with a chemical solution or the like allows the existing thermal spray coating 30 to be removed, thereby allowing a contribution to the regeneration of the glass part.

The glass pat according to the present embodiment is formed on the base film 20 of the glass substrate 10 provided with the base film 20 by forming the thermal spray coating 30 in accordance with a coating forming treatment. The thermal spray coating 30 can be provided to improve various functions and performance depending on the application of the glass part, and in particular, can be formed as a topcoat film exposed to the outermost surface. In particular, in the present embodiment, the thermal spray coating 30 (topcoat film) is formed on the base film 20, thus allowing the adhesion to the glass substrate 10 to be significantly improved as compared with a case where the thermal spray coating 30 is directly formed on the base surface of the glass substrate 10 without providing the base film 20.

The thermal spray coating 30 can be formed from a metal or a ceramic, and can be determined, based on the function and performance depending on the application of the glass part to be formed. In addition, the thermal spray coating 30 can also be selected in consideration of the adhesion to the base film 20. More specifically, the thermal spray coating 30 can be formed with the use of a material to provide the highest adhesion in combination with the base film 20. In this regard, the thermal spray coating 30 needs to be formed to be different in material, thickness, and/or surface roughness from the base film 20. This is because the material, thickness, and/or surface roughness of the base film 20 are determined exclusively from the viewpoint of the adhesion to the base surface of the glass substrate 10, whereas the material, thickness, and/or surface roughness of the thermal spray coating 30 are determined from the viewpoint of the function or performance depending on the application of the glass part to be formed. As a result, the glass part according to the present embodiment can also be regarded as a glass part with the two-layer thermal spray coating 30 formed on the base surface of the glass substrate 10. Furthermore, the thermal spray coating 30 provided on the base film 20 can be formed from two or more layers that are different in material, thickness, and/or surface roughness. As a result, when the base film 20 is also regarded as the thermal spray coating 30, the glass part can be also regarded as a glass part with the thermal spray coating 30 of three or more layers formed on the base surface of the glass substrate 10. Even in this case, however, the base film 20 and the thermal spray coating 30 are not formed at the same time, and thus, at the time of forming the base film 20, the product is regarded as the glass substrate 10 with the base film 20 according to the present embodiment.

The thermal spray coating 30 can be formed by thermal spraying, and can be formed by a chemical vapor deposition method (CVD), an atomic layer deposition method (ALD), a sputtering method, a vapor deposition method, a plating method, or a coating method. In comprehensive consideration of time and cost related to film formation, material characteristics required for applications of manufacturing devices such as semiconductors and liquid crystals, adhesion, and the like, however, the formation by a thermal spraying method is desirable. In particular, in the case of forming the thermal spray coating 30 by a thermal spraying method, the spraying method may be oxygen fuel spraying (flame spraying, high velocity flame spraying, detonation flame spraying), electric spraying (arc spraying, plasma spraying, or wire explosion spraying), or cold spraying. In addition, when the film thickness of the thermal spray coating 30 is 300 μm or more, the effect of improving the adhesion to the base surface of the substrate according to the present invention is remarkable, which is thus advantageous when the film thickness of the thermal spray coating 30 is 300 μm or more.

In the glass part (see FIG. 2) formed as described above, the thermal spray coating 30 is reliably brought into close contact with the glass substrate 10 by the base film 20, thus the problem of peeling the thermal spray coating 30 to be solved. In addition, the adhesion between the glass substrate 10 and the thermal spray coating 30 is improved in the glass part, and thus, even when the film thickness of the thermal spray coating 30 is increased, the risk of film peeling or substrate fracture associated with the increase can be eliminated to provide a glass part that can withstand severe use environments. Furthermore, for the glass part, the thermal spray coating 30 provided on the base film 20 can also be removed by removing the base film 20 with a chemical solution or the like as a component for dissolving the base film 20, and thus, newly forming the thermal spray coating 30 and the base film 20 can also make a great contribution to the regeneration of the glass part.

### EXAMPLE 1

Hereinafter, some experiments were performed for confirming the effects of the glass substrate and glass part according to the present embodiment. In particular, in the following experimental examples, quartz glass was used as a glass substrate, and a sprayed coating was formed by thermal spraying as a thermal spray coating, and the experiments were then performed.

### EXPERIMENTAL EXAMPLE 1

In this experimental example, the adhesion between the base surface and the sprayed coating was checked in the case of directly forming a thick sprayed coating with a film thickness in excess of 300 μm on the base surface of a quartz glass substrate Powder materials for thermal spraying, used in this experimental example, were an alumina (Al₂O₃) powder, a silicon (Si) powder, an yttria (Y₂O₃) powder, an alumina (Al₂O₃) coarse powder (coarser powder in particle size than the alumina powder), and yttria-stabilized zirconia (Y₂O₃-stabilized ZrO₂/abbreviation: YSZ) powder. The chemical composition of the YSZ powder was ZrO₂ (8 wt % Y₂O₃).

Sprayed coatings of 300 μm to 400 μm in film thickness were formed by atmospheric plasma spraying (APS) of the spray materials onto the base surface of a quartz glass substrate (50 mm long×50 mm wide×3 mm thick) subjected to surface roughening by a blasting treatment (blasting material: silicon carbide abrasive grains C #80, discharge air pressure: 0.4 MPa). For only the yttria-stabilized zirconia (YSZ) among the spray materials subjected to the experiment, however, the film formation was performed by water stabilizer plasma spraying (WPS) in addition to the atmospheric plasma spraying (APS). The thickness of a common sprayed coating in a quartz glass part for the application of semiconductor manufacture is approximately 150 μm to 200 μm, and the formation of a sprayed coating with a film thickness of 300 μm or more onto a quartz glass substrate that is extremely small in thermal expansion coefficient is a severe experimental condition.

Then, the surface roughness of the base surface, the film thickness of the sprayed coating, and the surface roughness of the sprayed coating for each spray material were examined For the surface roughness, the average value was determined from the results of measurement at arbitrary three points before and after the thermal spraying. The results are shown in Table 1 below. In Table 1, “YSZ-APS” represents YSZ formed by atmospheric plasma spraying (APS), and “YSZ-WPS” represents YSZ formed by water stabilizer plasma spraying (WPS).

TABLE 1

| | Film | Roughness of | | Roughness of | | |
|---|---|---|---|---|---|---|
| Spray | Thickness | Sprayed Coating[μm] | | Base[μm] | | |
| Material | [μm] | Ra | Rmax | Ra | Rmax | Remarks |
| Alumina | 379 | 3.5 | 35.2 | 4.5 | 43.1 | coating formed |
| Silicon | 385 | 2.8 | 27.1 | 4.6 | 46.5 | coating formed |
| Yttria | 376 | 5.3 | 51.0 | 4.4 | 46.7 | coating formed |
| Alumina | 394 | 4.5 | 43.0 | 4.5 | 45.8 | coating formed |
| Coarse | | | | | | |
| Powder | | | | | | |
| YSZ-APS | N/A | 9.4 | 110.9 | 4.4 | 48.8 | during application |
| | | | | | | of thermal spraying, |
| | | | | | | coating peeled |
| YSZ-WPS | N/A | 13.6 | 177.9 | 4.7 | 46.0 | during application |
| | | | | | | of thermal spraying, |
| | | | | | | coating peeled |

In this experiment, when the yttria-stabilized zirconia (YSZ) was used as the spray material, a sprayed coating up to about 200 μm in thickness could be formed on the quartz glass substrate, but the formation of a thick film in excess of 300 μm was difficult. In addition, in each case of the atmospheric plasma spraying (APS) and water stabilizer plasma spraying (WPS) as a thermal spraying method for forming the YSZ coating, the coating was peeled off from the substrate during the application of thermal spraying.

### EXPERIMENTAL EXAMPLE 2

In this experiment, the porosity was measured for the sprayed coatings formed by thermal spraying of the spray materials checked in Experimental Example 1. In particular, as for the yttria-stabilized zirconia (YSZ), sprayed coatings provided with a base film according to Experimental Example 4 described later were formed and measured for a YSZ (YSZ-APS) coating formed by atmospheric plasma spraying (APS) and a YSZ (YSZ-WPS) coating formed by water stabilizer plasma spraying (WPS).

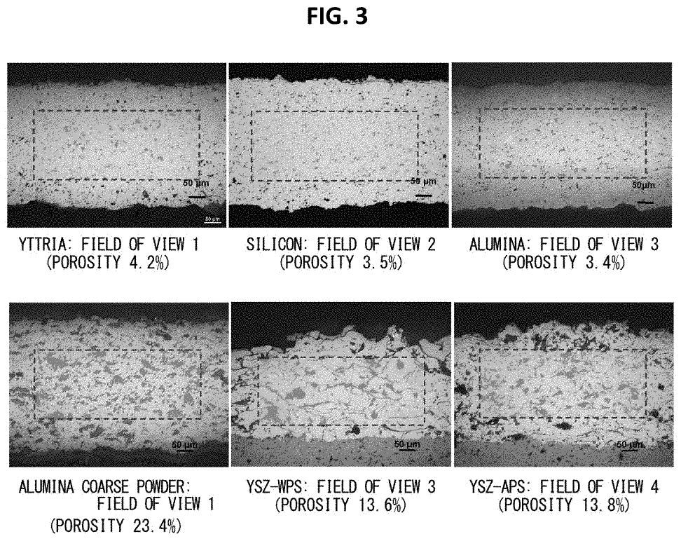

As a method for measuring the porosity of the sprayed coating, first, a magnified image (photographing magnification: 200 times) of a cross section of the sprayed coating was photographed, and then, the area of a pore portion in the cross-sectional image of the sprayed coating was measured and calculated with the use of image analysis software (“WinROOF” manufactured by MITANI CORPORATION). For each sprayed coating, the porosity obtained by measuring 5 fields (field of view 1 to 5) is shown in Table 2, and the cross-sectional image (the field of view * in Table 2) of the coating, binarized by image analysis, is shown in FIG. 3. The size of the porosity measurement region in the cross-sectional image of the coating was 500 μm×200 μm.

TABLE 2

| | | | | | | | Alumina |
|---|---|---|---|---|---|---|---|
| Spray Material | | Alumina | Silicon | Yttria | YSZ-APS | YSZ-WPS | Coarse Powder |
| Porosity | Field of | 3.2 | 3.6 | 4.2 ※ | 18.0 | 17.2 | 23.4 ※ |
| [%] | View 1 | | | | | | |
| | Field of | 4.0 | 3.5 ※ | 4.5 | 13.4 | 18.6 | 24.4 |
| | View 2 | | | | | | |
| | Field of | 3.4 ※ | 3.7 | 4.1 | 15.0 | 13.6 ※ | 23.2 |
| | View 3 | | | | | | |
| | Field of | 3.3 | 3.4 | 3.9 | 13.8 ※ | 12.8 | 21.7 |
| | View 4 | | | | | | |
| | Field of | 3.1 | 3.6 | 4.4 | 16.3 | 15.0 | 20.3 |
| | View 5 | | | | | | |
| | N = 5 | 3.4 | 3.5 | 4.2 | 15.3 | 15.4 | 22.6 |
| | Average | | | | | | |

### EXPERIMENTAL EXAMPLE 3

In this experiment, sprayed coatings of 300 μm to 400 μm in film thickness were formed on a base obtained by surface roughening of a substrate made of quartz glass by a blasting treatment (blasting material: silicon carbide abrasive grains C #80, discharge air pressure: 0.4 MPa), by atmospheric plasma spraying with the use of an alumina (Al₂O₃) powder, a silicon (Si) powder, a yttria (Y₂O₃) powder, and an alumina (Al₂O₃) coarse powder (coarser powder in particle size than the alumina powder) as spray materials. Then, the thickness and surface roughness of the sprayed coating, the surface roughness of the quartz glass substrate, and the tensile adhesion strength (hereinafter, referred to as tensile strength) of the coating were measured for each sprayed coating. The YSZ powder was excluded from the measurement targets in Experimental Example 3, because any coating failed to be formed on the quartz glass substrate as in the result of Experiment 1.

The tensile strength of the coating was measured with reference to JIS H 8402 “Test method of tensile adhesion strength for thermal-sprayed coatings”. More specifically, a test piece was prepared by spraying the spray material onto one roughened surface of the quartz glass substrate (outer diameter: 25 mm, thickness: 5 mm), and then, a head of a hexagonal bolt made of stainless steel (SUS 304) was butted and bonded to both end surfaces of the test piece subjected to the thermal spraying. For the bonding, a two-component mixed epoxy adhesive (trade name “DP-460” manufactured by 3M Japan Limited) was used to confirm in advance that a product of quartz glass and SUS 304 bonded was about 50 MPa in tensile adhesion strength. For the test piece thus prepared, the tensile strength was measured with a precision universal tester (“AG-100kNX” manufactured by Shimadzu Corporation). The conditions for the test were a tensile rate of 1 mm/min and the number of test pieces N=3 in accordance with JIS H 8402.

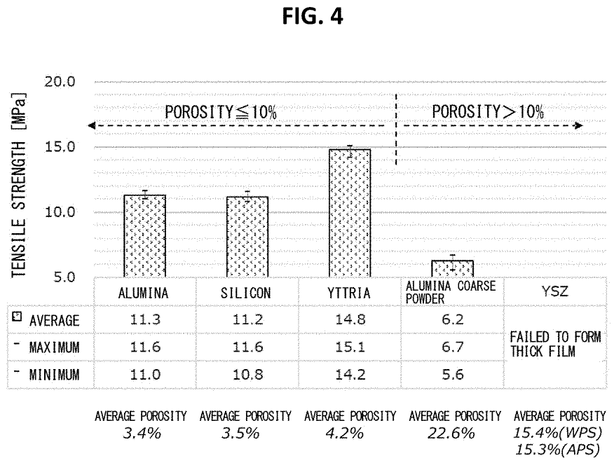

For each sprayed coating, the film thickness and surface roughness of the sprayed coating, the surface roughness of the quartz glass substrate, and tensile strength were measured, the condition of the peeled surface is shown in Table 3 below, and the relationship between the porosity and the tensile strength is shown in FIG. 4.

In this experimental result, the three test pieces for each spray material were all delaminated at the interface between the coating and the substrate, without any large individual difference in appearance among the test pieces.

In addition, the yttria-stabilized zirconia (YSZ) sprayed coating failed to form a thick film in excess of 300 μm, thus causing the tensile test to fail to be conducted, but this is believed to be mainly because of the excessively large difference in thermal expansion coefficient between the quartz glass and the yttria-stabilized zirconia (YSZ).

From the experimental results of the alumina and alumina coarse powder, it has been then confirmed that the sprayed coatings of the same material that differ in porosity have a difference produced in adhesion. This is believed to be because the dense coating was higher in tensile strength than the porous coating, thus producing a difference in anchor effect due to a difference in area of contact between the coating and the substrate base.

Furthermore, as for the yttria (Y₂O₃) and silicon (Si) with the same degree of porosity, the thermal expansion coefficient is “Si<Y₂O₃”, and the tensile strength is “Si<Y₂O₃” while the thermal expansion coefficient of the Si is closer to that of the quartz glass of the substrate, and it has been confirmed that the Y₂O₃ that is larger in thermal expansion coefficient than the quartz glass of the substrate is higher in tensile strength.

From the foregoing, it has been confirmed that the magnitude relationship of the tensile strength for each sprayed coating with respect to the quartz glass substrate subjected to the base control under the same conditions fails to be determined only by the thermal expansion coefficient and porosity of the coating. Furthermore, the adhesion between the sprayed coating of the yttria (Y₂O₃) and the quartz glass substrate has been also found to be particularly high.

### EXPERIMENTAL EXAMPLE 4

Attention was paid to the high adhesion between the sprayed coating of the yttria (Y₂O₃) and the quartz glass substrate in the results of Experimental Example 3, and it has been confirmed as follow that the yttria-stabilized zirconia (YSZ), which was difficult to form in a thick film onto the quartz glass substrate, is formed in a thick film, with yttria (Y₂O₃) used as a base film.

More specifically, a target region of a substrate (50 mm long×50 mm wide×3 mm thick) made of quartz glass was subjected to surface roughening by a blasting treatment (blasting material: silicon carbide abrasive grains C #80, discharge air pressure: 0.4 MPa), and an yttria (Y₂O₃) coating with a film thickness of 100 μm or more was formed as a base film by atmospheric plasma spraying (APS). Then, on the base film, a topcoat film (coating) with a film thickness of 300 μm or more was formed by atmospheric plasma spraying (APS) and water stabilizer plasma spraying (WPS) of yttria-stabilized zirconia (YSZ). Then, the film thicknesses of the base film and coating, and the porosity and surface roughness of the coating were measured, and the presence or absence of any coating formed was checked. The results are shown in Table 4 below together with the results of Experimental Example 1.

TABLE 4

| Composition of | | Film Thickness | | Average | Surface Roughness | | Surface Roughness | | Presence or | |
|---|---|---|---|---|---|---|---|---|---|---|
| Sprayed Film | | [μm] | | Porosity | of Coating [μm] | | of Base Surface [μm] | | Absence of | |
| Topcoat Film | Base Film | Coating | Base Film | [%] | Ra | Rmax | Ra | Rmax | Coating Formed | Remarks |
| Alumina | None | 379 | None | 3.4 | 3.5 | 35.2 | 4.5 | 43.1 | Coating Formed | Experimental |
| | | | | | | | | | | Example 1 |
| Silicon | None | 385 | None | 3.5 | 2.8 | 27.1 | 4.6 | 46.5 | Coating Formed | Experimental |
| | | | | | | | | | | Example 1 |
| Yttria | None | 376 | None | 4.2 | 5.3 | 51.0 | 4.4 | 46.7 | Coating Formed | Experimental |
| | | | | | | | | | | Example 1 |
| Alumina | None | 394 | None | 22.6 | 4.5 | 43.0 | 4.5 | 45.8 | Coating Formed | Experimental |
| Coarse | | | | | | | | | | Example 1 |
| Powder | | | | | | | | | | |
| YSZ-APS | None | N/A | None | N/A | 9.4 | 110.9 | 4.4 | 48.8 | Coating Peeled | Experimental |
| | | | | | | | | | | Example 1 |
| YSZ-WPS | None | N/A | None | N/A | 13.6 | 177.9 | 4.7 | 46.0 | Coating Peeled | Experimental |
| | | | | | | | | | | Example 1 |
| YSZ-APS | Yttria | 387 | 144 | 15.3 | 9.6 | 90.0 | 4.5 | 46.8 | Coating Formed | Experimental |
| | | | | | | | | | | Example 4 |
| YSZ-WPS | Yttria | 350 | 140 | 15.4 | 13.9 | 123.1 | 4.3 | 47.4 | Coating Formed | Experimental |
| | | | | | | | | | | Example 4 |

From these experiments, it has been confirmed that even the yttria-stabilized zirconia (YSZ), which failed to form a coating directly on a quartz glass substrate, allows the formation of a base film made of yttria (Y₂O₃) with a porosity less than 5%, and allows the formation of a thick film by thermal spraying onto the base film.

In particular, in this experimental example, the substrate base fails to be completely covered, unless the base film has a thickness that is equal to or larger than the value of the maximum height roughness Rmax at the surface roughness of the base film. In addition, the target region of the quartz glass substrate subjected to the blasting treatment also has irregularities associated with the surface roughening, and a film thickness for covering the irregularities with the base film is also required. Thus, in order to reliably cover the substrate base with the base film, the base film is desirably formed to have a film thickness that is equal to or more than the sum of the value of the surface roughness (maximum height roughness Rmax) at the base film and the value of the surface roughness (maximum height roughness Rmax) in the target region of the quartz glass substrate. Thus, in the present experimental example, for a thickness of 98 μm that is the sum of the surface roughness (Rmax: 51 μm) of the yttria (Y₂O₃) film to serve as the base film and the surface roughness (Rmax: 47 μm) in the target region of the quartz glass substrate, the base film made of yttria (Y₂O₃) was formed to have a film thickness of 100 μm or more also in consideration of the amount of variation.

### EXPERIMENTAL EXAMPLE 5

In this experimental example, in relation to Experimental Examples 3 and 4, a base film made of the yttria (Y₂O₃) was formed also for sprayed coatings obtained with the use of various spray materials, and a tensile adhesion strength test was conducted for checking the adhesion of the base film.

More specifically, a target region of a substrate (50 mm long×50 mm wide×3 mm thick) made of quartz glass was subjected to surface roughening by a blasting treatment (blasting material: silicon carbide abrasive grains C #80, discharge air pressure: 0.4 MPa) in the same manner as in Experimental Example 4, and an yttria (Y₂O₃) coating with a film thickness of 100 μm or more was formed as a base film by atmospheric plasma spraying (APS).

Then, alumina (Al₂O₃), silicon (Si), yttria-stabilized zirconia (YSZ), and alumina (Al₂O₃) coarse powder were sprayed onto the base film by atmospheric plasma spraying (APS) to form topcoat films (coatings) of 300 μm or more in film thickness. Then, the film thicknesses of the base film and coating, the surface roughness of the coating and substrate, and tensile strength were measured, and the condition of the peeled surface was examined The tensile strength was measured by the same method as in Experimental Example 3. The results are shown in Table 5 below.

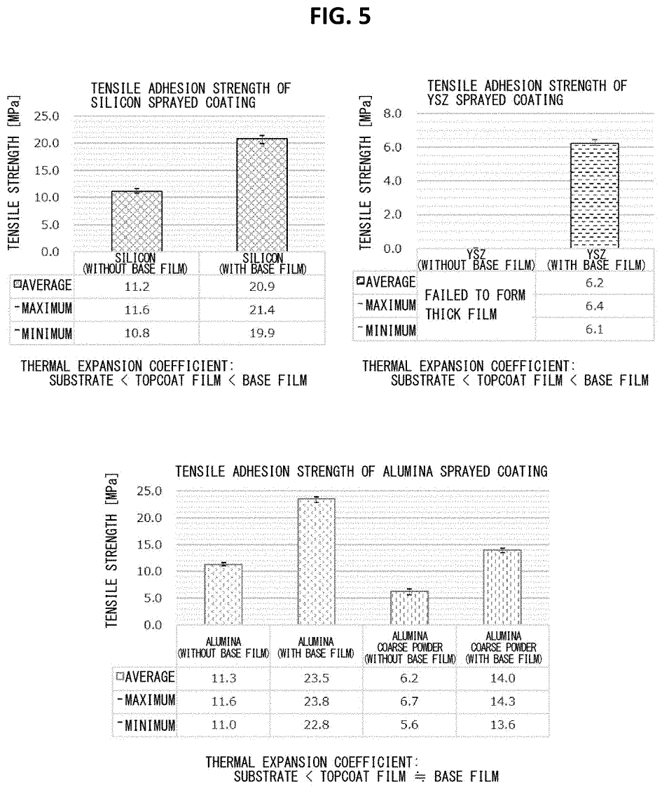

In this experimental example, the observation of the peeled surfaces after the tensile test determined that there was no base film peeled from the quartz glass base. More specifically, from this experimental result, the test result obtained indicates extremely high adhesion between the base film made of yttria (Y₂O₃) and the quartz glass base surface. In addition, it has been confirmed that when the sprayed coatings of the alumina (Al₂O₃), silicon (Si), yttria-stabilized zirconia (YSZ), and alumina (Al₂O₃) coarse powder were formed on the base film made of yttria (Y₂O₃), the tensile adhesion strength was significantly improved as compared with the case where the sprayed coatings were formed directly without providing the base film. The comparison results are shown in FIG. 5.

As shown in FIG. 5, the sprayed coating of silicon (Si) was formed as a topcoat film on the base film of yttria (Y₂O₃), thereby improving the tensile strength to 1.9 times as compared with the case where the base film of Y₂O₃ was not provided. In addition, in the case of the yttria-stabilized zirconia (YSZ), any coating failed to be formed on the quartz glass base surface, but providing the base film of Y₂O₃ made it possible to form a coating. Further, in the case of forming the sprayed coating of alumina (Al₂O₃) as a topcoat film, the tensile strength was improved to 2.1 times by providing the base film of Y₂O₃ as compared with the case where the base film was not provided, and in the case of forming the sprayed coating of the coarse powder of Al₂O₃ (Al₂O₃ coarse powder) as the same material, the tensile strength was improved to 2.2 times by providing the base film of Y₂O₃ as compared with the case where the base film was not provided. According to these embodiments, the initial effect can be obtained, because the topcoat film on any outermost surface has the sprayed coating made of the initially intended spray material.

### EXPERIMENTAL EXAMPLE 6

As presented in Experimental Examples 4 and 5 mentioned above, the adhesion of the topcoat film to the quartz glass base can be enhanced by forming the sprayed coating as the topcoat film on the based film of yttria (Y₂O₃) provided. Furthermore, a sprayed coating as a topcoat film is formed on the base film provided, thereby allowing the glass part to be regenerated with the use of the chemical resistance characteristics of the base film. Thus, in this experimental example, the regeneration of a sprayed coating is checked with the use of the chemical resistance characteristics of the quartz glass substrate and Y₂O₃ as the base film. Specifically, the quartz glass substrate is insoluble in nitric acid, whereas Y₂O₃ is soluble in nitric acid, and thus, the chemical characteristics are applied to regenerate the glass part. In this case, even if the topcoat film is made of a material that is insoluble in nitric acid, and membranous (dense) without pores, the Y₂O₃ film for the base film is dissolved by side etching through the permeation of the chemical solution from the end of the topcoat film. In addition, when the topcoat film is a sprayed coating, the topcoat film is membranous (porous) with pores, the chemical solution is thus likely to permeates from the outermost surface of the coating to the lowermost surface (interface with the base film) thereof, thereby easily dissolving the Y₂O₃ film for the base film.

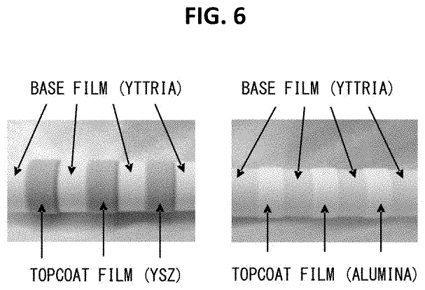

In this experimental example, the surface of a cylindrical quartz glass substrate of 18 mm in outer diameter×16 mm in inner diameter×200 mm in length was subjected to surface roughening by a blasting treatment (blasting material: silicon carbide abrasive grains C #80, discharge air pressure: 0.4 MPa), a base film made of yttria (Y₂O₃) with a film thickness of 110 μm was then formed in the roughened region, and on the base film, coatings (topcoat films) were formed by atmospheric plasma spraying (APS). In particular, in this experimental example, sprayed coatings with a thickness of 500 μm were formed as topcoat films with the use of yttria-stabilized zirconia (YSZ) and alumina (Al₂O₃), and as shown in FIG. 6, the topcoat films were formed in strip shapes so as to cover the circumference for the cylindrical quartz glass substrate.

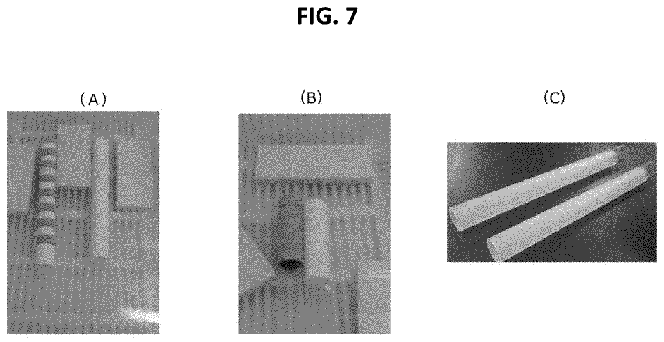

Thereafter, the films were immersed for 24 hours in a nitric acid aqueous solution (61 wt % nitric acid (undiluted solution):deionized water=1:10 in terms of volume ratio) as a base film dissolving component. FIG. 7 shows the conditions of the quartz glass substrate (A) before the immersion, (B) after the immersion, and (C) after the immersion in the base film dissolving component (nitric acid aqueous solution). As shown in FIG. 7B, after the immersion in the base film dissolving component (nitric acid aqueous solution) for 24 hours, the yttria (Y₂O₃) as the base film is dissolved, and the strip-shaped sprayed coatings formed as the coatings (topcoat films) are freely movable from the cylindrical substrate, and close to one end in the length direction. Further, as shown in FIG. 7C, it has been confirmed that even after the immersion in the base film dissolving component (nitric acid aqueous solution), the quartz glass substrate subjected to the surface roughening was not damaged, and can be reused for newly forming coatings (topcoat films) and base films.

The glass substrate with the base film for the adhesion of a thermal spray coating and the glass part provided with the coating according to the present invention can be used for a glass substrate with the enhanced adhesion of a metal or ceramic coating such as a sprayed coating, and a glass part with the glass substrate used, and particularly desirably, can be used as a chamber constituent member of an apparatus for manufacturing a device such as a semiconductor or a flat panel display. In addition, the glass substrate provided with the base film and the glass component with the glass substrate used according to the present inventio can be used for recycling the glass substrate.

What is claimed is:

1. A quartz glass substrate with a sprayed coating of a metal or a ceramic formed,
wherein a region with the sprayed coating formed is provided with a base film that is a sprayed coating of yttria with a porosity of 10% or less.

2. The quartz glass substrate according to claim 1, wherein a target region of the quartz glass substrate with the base film formed has surface roughness of 3.5 μm to 5.5 μm in arithmetic mean roughness Ra and 35 μm to 55 μm in maximum height roughness Rmax.

3. The quartz glass substrate according to claim 1, wherein the base film has a thickness of 100 μm or more.

4. A quartz glass part comprising a quartz glass substrate provided with a sprayed coating of a metal or a ceramic,
wherein the quartz glass substrate is the quartz glass substrate according to claim 1, and
the sprayed coating is formed on the base film.

5. The quartz glass part according to claim 4, wherein the sprayed coating formed on the base film has a thickness in excess of 300 μm, and
the base film is formed to have a thickness that is equal to or more than a sum of a value of surface roughness (maximum height roughness Rmax) at the base film and a value of surface roughness (maximum height roughness Rmax) in a target region of the quartz glass substrate.

6. A method for manufacturing a quartz glass part obtained by forming a sprayed coating of a metal or a ceramic on a quartz glass substrate, the method comprising:
a base film forming treatment of spraying yttria onto the quartz glass substrate to form a base film with a porosity of 10% or less; and
a coating forming treatment of forming the sprayed coating of the metal or ceramic on the base film formed by the base film forming treatment.

7. A method for regenerating the quartz glass part manufactured by the method for manufacturing the quartz glass part according to claim 5, the method comprising:
a base film dissolving treatment of dissolving the base film with a base film dissolving component in which the base film is soluble, whereas the quartz glass substrate is insoluble,
wherein a chemical solution containing a nitric acid is used as the base film dissolving component.
